(19) United States
(12) Patent Application Publication
(10) Pub. No.: US 2024/0282037 A1
(43) Pub. Date: Aug. 22, 2024

(54) METHOD FOR SIMULATING OBJECT MOTION BY MEANS OF PARTICLES AND DEVICE

(71) Applicant: Beijing Bytedance Network Technology Co., Ltd., Shijingshan District, Beijing (CN)

(72) Inventors: Liyou XU, Beijing (CN); Huaiye SHEN, Beijing (CN); Yi GUO, Beijing (CN); Jiali PAN, Beijing (CN)

(21) Appl. No.: 18/567,730

(22) PCT Filed: Sep. 16, 2022
(86) PCT No.: PCT/CN2022/119408

§ 371 Date: Dec. 6, 2023

(30) Foreign Application Priority Data
Oct. 18, 2021 (CN) 202111209153.3

(51) Int. Cl. G06T 13/80

(52) U.S. Cl. CPC G06T 13/80

(57) ABSTRACT

Embodiments of the present disclosure provide a method and apparatus for simulating object motion by particles, an electronic device, a storage medium, a computer program and a computer program product, which relate to the technical field of computer processing. The method comprises: generating a first number of particles, each of the particles comprising one or more pixel points, the motion process of the first number of particles forming animation effects which are used for simulating motion effects of the object in a real environment; updating a location of the particles based on a motion control parameter during the motion process, the motion control parameter being a parameter that affects the motion; displaying the particles based on the updated location of the particles. The embodiments of the present disclosure can determine the location of the particles during motion through a motion control parameter.

### CROSS-REFERENCE TO RELATED APPLICATION(S)

This application claims priority to Chinese Application No. 202111209153.3 filed with the Chinese Patent office on Oct. 18, 2021 and entitled “method and device for simulating the motion of object by particles,” the disclosure of which is incorporated herein by reference in its entity.

### FIELD

The present disclosure relates to the technical field of computer processing, and in particular, to a method and apparatus for simulating object motion by means of particles, an electronic device, a storage medium, a computer program and a computer program product.

### BACKGROUND

With the increasing power of computer processing, computers can generate a variety of rich animation effects. For example, animation effects can be used to simulate fireworks. At this point, fireworks can be construed as being formed by a large number of particles, each of which is formed by one or more pixel dots. Thus, fireworks can be simulated by a large number of pixel dots, wherein the simulating fireworks comprise: simulating the rising process of fireworks, simulating the explosion process of fireworks, simulating the dissipation process of fireworks.

In the above process of simulating animation effects, it is necessary to guarantee the authenticity of animation effects, for example, it is necessary to ensure that the simulated fireworks are as close as possible to the real fireworks. In this way, how to improve the authenticity of animation effects becomes an urgent problem to be solved.

### SUMMARY

Embodiments of the present disclosure provide a method and apparatus for simulating object motion by particles, an electronic device, a storage medium, a computer program and a computer program product, which can improve the authenticity of animation effects.

In a first aspect, an embodiment of the present disclosure provides a method of simulating object motion by particles, comprising:
Generating a first number of particles, each of the particles comprising one or more pixel points, the motion process of the first number of particles forming animation effects which are used for simulating motion effects of the object in a real environment;
Updating a location of the particles based on a motion control parameter during the motion process, the motion control parameter being a parameter that affects the motion;
Displaying the particles based on the updated location of the particles.

In a second aspect, an embodiment of the present disclosure provides an apparatus for simulating object motion by particles, comprising:
A particle generating module, configured for generating a first number of particles, each of the particles comprising one or more pixel points, the motion process of the first number of particles forming animation effects which are used for simulating motion effects of the object in a real environment;
A location update module, configured for a location of the particles based on a motion control parameter during the motion process, the motion control parameter being a parameter that affects the motion;
A first display module, configured for displaying the particles based on the updated location of the particles.

In a third aspect, an embodiment of the present disclosure provides an electronic device, comprising: at least one processor and a memory;
The memory storing computer executable instructions;

The processor executing the computer executable instructions stored in the memory to cause the electronic device to perform a method as described in the first aspect.

In a fourth aspect, an embodiment of the present disclosure provides a computer-readable storage medium, on which computer executable instructions are stored, the computer executable instructions, when executed by a processor, causing a computing device to perform a method as described in the first aspect.

In a fifth aspect, an embodiment of the present disclosure further provides a computer program, the computer program being used for performing a method as described in the first aspect.

In a sixth aspect, an embodiment of the present disclosure further provides a computer program product, comprising a computer program which, when executed by a processor, performing a method as described in the first aspect.

The embodiments of the present disclosure provide a method and apparatus for simulating object motion by particles, an electronic device, a storage medium, a computer program and a computer program product. The method comprises: generating a first number of particles, each of the particles comprising one or more pixel points, the motion process of the first number of particles forming animation effects which are used for simulating motion effects of the object in a real environment; updating a location of the particles based on a motion control parameter during the motion process, the motion control parameter being a parameter that affects the motion; displaying the particles based on the updated location of the particles. The embodiments of the present disclosure can determine the location of the particles during motion through a motion control parameter. Since the motion control parameter is a parameter that affects the motion, it is possible to simulate the motion of an object in a real environment and improve the authenticity of animation effects.

### BRIEF DESCRIPTION OF THE DRAWINGS

In order to more clearly illustrate the technical solution of the embodiments of the present disclosure or in the prior art, a brief introduction is presented below to the accompanying drawings used herein. It is obvious that the accompanying drawings to be described below are some embodiments of the present disclosure, and those of ordinary skill in the art may further obtain other drawings according to these accompanying drawings without the exercise of any inventive skill.

FIG. 1 shows a schematic diagram of the rising process of fireworks;

FIG. 2 shows a schematic diagram of explosion of fireworks after rising to a certain location;

FIG. 3 shows a schematic flowchart of the steps of a method of simulating object motion by particles provided by an embodiment of the present disclosure;

FIG. 4 shows a schematic diagram of a target image area that is text provided by an embodiment of the present disclosure;

FIG. 5 shows a schematic diagram of a target image area that is a pattern provided by an embodiment of the present disclosure;

FIG. 6 shows a schematic diagram of an image sequence provided by an embodiment of the present disclosure;

FIG. 7 shows a schematic diagram of a relationship between an amplifying speed and an amplifying factor provided by an embodiment of the present disclosure;

FIG. 8 shows a schematic diagram of a relationship between an amplifying speed and a transparency provided by an embodiment of the present disclosure;

FIG. 9 to FIG. 13 show a schematic diagram of a second image displayed at a moment t1, t2, t3, t4, t5 and t6 respectively;

FIG. 14 shows a structural block diagram of an apparatus for simulating object motion by particles provided by an embodiment of the present disclosure;

FIG. 15 and FIG. 16 show a structural block diagram of two electronic devices provided by an embodiment of the present disclosure respectively.

### DETAILED DESCRIPTION OF EMBODIMENTS

To make the objectives, technical solution and advantages of the embodiments of the present disclosure clearer, the technical solution of the embodiments of the present disclosure will be clearly and completely described in conjunction with the accompanying drawings. It is apparent that the embodiments to be described are merely part of rather than all the embodiments of the present disclosure. Based on the embodiments of the present disclosure, all other embodiments obtained by those of ordinary skill in the art without the exercise of any inventive skill fall within the protection scope of the present disclosure.

The embodiments of the present disclosure may be applied to the simulation process of animation effects, i.e., the process of simulating animation effects through a large number of particles. Wherein the animation effects are image effects formed by the motion of a large number of particles, including but not limited to, fireworks effects, cloud effects, volcanic eruption effects, flames effects.

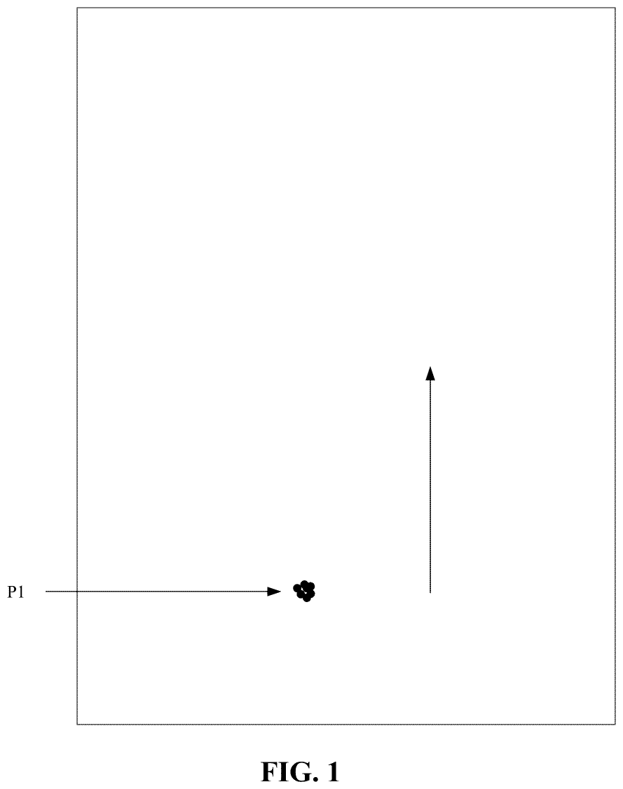

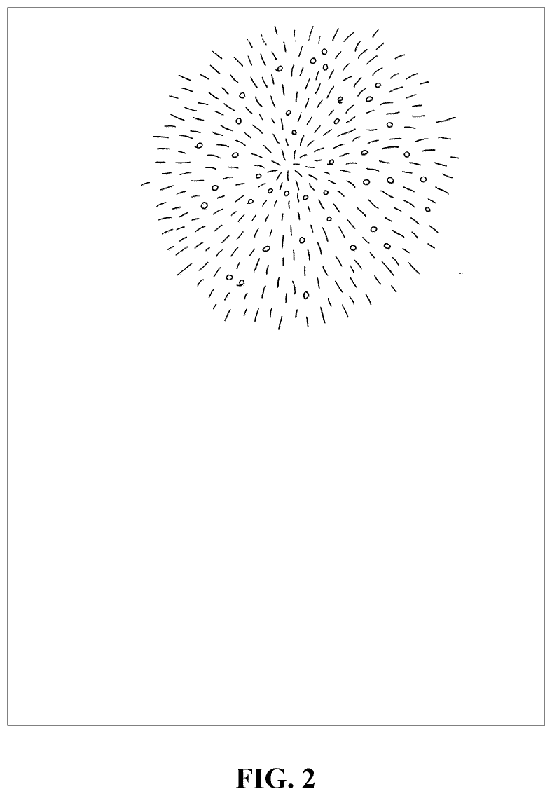

FIG. 1 shows a schematic diagram of the rising process of fireworks, and FIG. 2 shows a schematic diagram of fireworks exploding after rising to a certain location. With reference to FIG. 1, multiple particles form fireworks moving upward from the bottom, and with reference to FIG. 2, the fireworks explode when these particles rise to a certain location.

It can be seen that the above fireworks effect is realized through particle effect, which refers to the ability encapsulation of special rendering effects.

The above particles have a life cycle, which consists of an initialization stage, an update stage and a rendering stage.

Wherein the initialization stage is used for defining an initial state of the particle, i.e., the initialization of attributes of the particle, such as the location, size, color and velocity of the particle.

The update stage is used for updating attributes of the particle during motion, including color, transparency, size, location, and direction of motion. Transparency is the alpha channel of the color, with a value range usually between 0 and 1, wherein alpha=1 means opaque, alpha=0 means completely transparent. In addition to the above-mentioned attributes of particle that need to be updated, attributes of the particle further include some attributes that do not need to be updated, such as the lifetime and mass of the particle.

The rendering stage is used for displaying the particle subsequent to being initialized or updated. During display, the particle may be replaced with a model, which may be a two-dimensional or three-dimensional model. The rendering process may be implemented using a rendering pipeline, which is a geometry shader for processing vertex information in real time and generating geometry. The working mode of the rendering pipeline may comprise three: a point mode, a triangular faceted mode, and a quad faceted mode. In the point mode, particles rendered by the rendering pipeline are points. In the triangular faceted mode, particles rendered by the rendering pipeline are triangles. In the quad faceted mode, particles rendered by the rendering pipeline are quadrilaterals.

In the prior art, the speed of the above particles during motion is fixed. In reality, however, fireworks, flames, volcanic eruptions and clouds are affected by the environment and other factors, and thus do not move at fixed speed. This, in turn, results in a less realistic simulated animation effect.

To solve the above-described problem, the embodiments of the present disclosure may determine the location of a particle during motion through a motion control parameter. Since the motion control parameter is a parameter that affects the motion, it is possible to simulate the motion of an object in a real environment and improve the authenticity of the animation effect.

By way of several specific embodiments, a detailed illustration is presented below to the technical solution of the embodiments of the present disclosure and how to solve the above technical problem by the technical solution disclosed herein. These specific embodiments may be combined with each other, and the same or similar concepts or processes might not be repeated in some embodiments. With reference to the accompanying drawings, the embodiments of the present disclosure are described below.

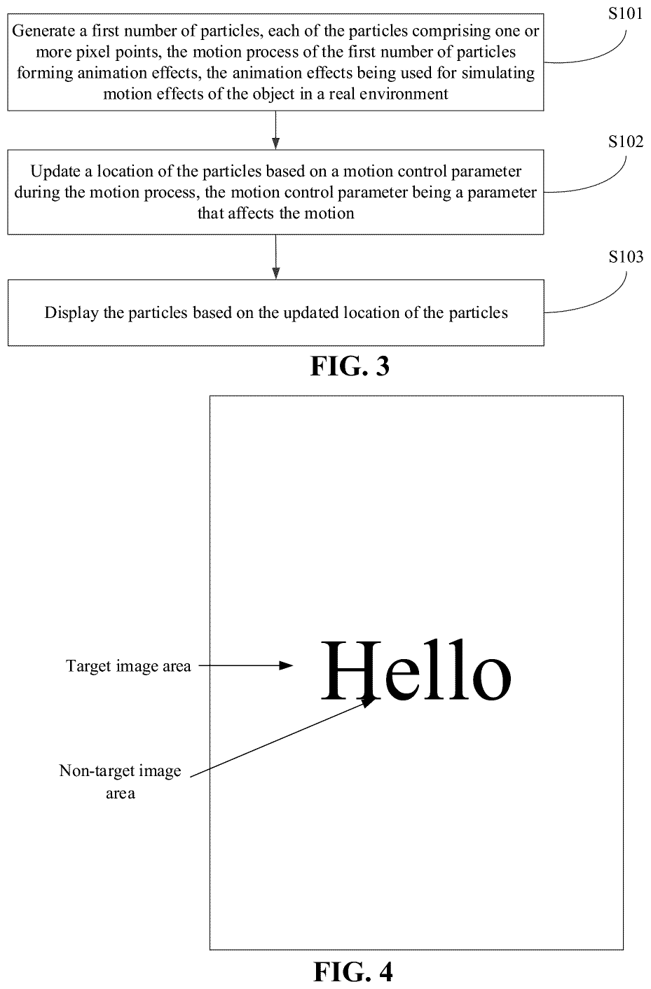

FIG. 3 shows a flowchart of the steps of a method of simulate object motion by particles provided by an embodiment of the present disclosure. The method shown in FIG. 3 may be applied in an electronic device. With reference to FIG. 3, the method of simulate object motion by particles comprises:

S101: generating a first number of particles, each comprising one or more pixel points, the motion process of the first number of particles forming an animation effect, which is used for simulating a motion effect of the object in a real environment.

When generating the first number of particles, at least one of attributes of the first number of particles in an initial state may be set: a shape formed by the first number of particles, a size of the shape, a color of each particle, a location of each particle, and a speed of each of the particles.

Wherein the shape may be a two-dimensional shape, such as a rectangle, a circle, a trapezoid, and an irregular figure. Of course, the shape may further be a three-dimensional shape, such as a cube, a sphere, a cylinder, an irregular geometry.

The size of the shape needs to be determined based on the dimension of the shape. For example, regarding a two-dimensional shape, it may be represented through a length, and/or width, and/or height, and/or area; regarding a three-dimensional shape, it may be represented through a length, and/or width, and/or height, and/or volume.

It is noteworthy that different particles may have the same or different colors, have different locations, and have the same or different speed.

Certainly, the location of the particles is an initial location and needs to be updated through S102 so as to reflect the rising process of the particles.

To generate the first number of particles, the embodiments of the present disclosure provide two examples.

In a first example, the first number of particles may be randomly generated. That is, the location of each particle is randomly set, the speed of each particle is randomly set, and the color of each particle is also randomly set. Of course, if it is necessary to guarantee that the first number of particles form a target shape with a target size, the location of the particles may be defined based on the target size and target shape.

In the embodiments of the present disclosure, to further enrich the display effect of animation effects, the particles may be arranged into a target display object, which may be text, a pattern, etc.

In a second example, first of all, a second number of particles are randomly generated; then, particles located in a target image area in the second number of particles are determined as the first number of particles, the target image area including particles needed to form the target display object.

Wherein the second number is greater than the first number, and the algorithm of generating the second number of particles may be referred to the process of generating the first number of particles in the first example, which is not detailed here.

Based on the second number of particles, the first number of particles may be filtered out from the second number of particles through the target image area. The target image area is related to the type of the target display object.

When the target display object is text, the target image area is an image area where strokes of the text are located. FIG. 4 shows a schematic diagram of a target image area that is text as provided by the embodiments of the present disclosure. With reference to FIG. 4, the image area where the strokes of the text “hello” is the target image area, and the blank area between the letters “he,” “ll” and “o” as well as the rest of the blank area is a non-target image area. Wherein the target image area may be obtained from a standard delay format (SDF) file, which is also referred to as a text map.

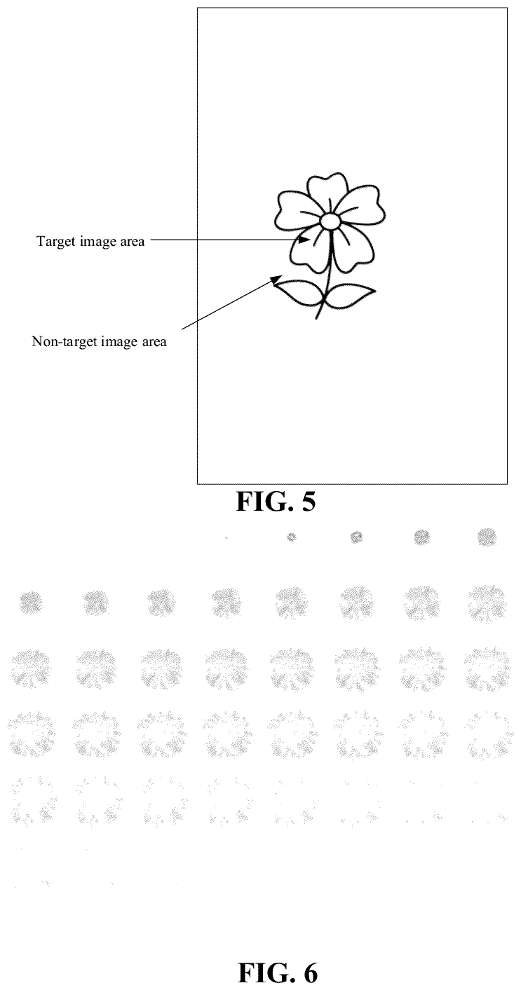

When the target display object is a pattern, the target image area is an image area where an effective part of the pattern is located. FIG. 5 shows a schematic diagram of a target image area that is a pattern as provided by the embodiments of the present disclosure. With reference to FIG. 5, an area formed by the outline of the flower is the target image area, and the remaining area outside the outline of the flower is a non-target image area.

S102: updating a location of the particles based on a motion control parameter during the motion process, the motion control parameter being a parameter that affects the motion.

Specifically, each time the location of the particles is updated, the acceleration may first be determined based on the motion control parameter, and then the location of the particles may be determined based on the acceleration.

The motion control parameter is related to a simulation environment. When the simulation environment is space, the motion control parameter is a gas resistance parameter and gas interference parameter in space; when the simulation environment is the earth, the motion control parameter includes a gravity parameter, air resistance parameter and air disturbance parameter.

When the motion control parameter includes the gravity parameter, air resistance parameter and air disturbance parameter, the process of determining the acceleration may comprise: first, determining a vector sum of the gravity parameter, air resistance parameter, and air disturbance parameter; and then, calculating a ratio of the vector sum to a preset particle mass to obtain the acceleration.

After obtaining the acceleration, the location of the particles is updated based on the acceleration, and the updated location is a sum of the location and distance before the update. When the location of the particles is updated for the first time, the location before the update is the location set in S101.

Based on the embodiments of the present disclosure, the acceleration may be determined through the gravity parameter, the air resistance parameter and the air disturbance parameter, so that the simulated rising process of the particles is affected by the gravity, air resistance, air disturbance and other factors, which improves the authenticity of the fireworks.

The updating the location of the particles through the motion control parameter may relate to each particle or one of the particles. For example, for the particle at the center location, the location of the particle is updated through the motion control parameter, while the location of the rest of the particles is updated based on the location of the particle. That is, the location of the rest of the particles is updated under the condition that the relative location relationship between the particles remains unchanged.

S103: displaying the particles based on the updated location of the particles.

Specifically, the particles are displayed at the updated location of the particles. Of course, while displaying the particles, the color of the particles is also considered.

It is noteworthy that in practical application, the location of the particles needs to be updated continuously, and the particles need to be displayed after each update of the location of the particles. That is, S102 and S103 are continuously performed at preset time intervals. For example, S102 and S103 may be performed once every t millisecond.

In practical application, objects in motion will have a trailing phenomenon due to visual delays. That is, for fast moving objects, we will see that there is a trailing in the motion process. The embodiments of the present disclosure may realize this trailing phenomenon by continuously decreasing the pixel value of the image of the previous frame to further improve the richness of the animation effect. Specifically, when displaying the particles based on the updated location of the particles, first of all, a first image displayed at a previous moment may be obtained, the first image comprising the first number of particles; then, a pixel value of each pixel point included in the particles in the first image is reduced to obtain an updated first image; afterwards, a second image is generated based on the updated first image and the updated location of the particles; finally, the second image is displayed, the second image comprising the pixel points with reduced pixel values and the first number of particles with the updated location.

Wherein the first image is the image displayed at a previous moment, and the second image is the image with a trailing effect at a current moment. As time elapses, the second image turns into the first image, so the second image needs to be continuously generated based on the first image.

FIG. 1 shows a second image P1 displayed at a moment t1. Since the particles are generated at the moment t1, there is no moment prior to t1, and further P1 only comprises the particles generated at the current moment t1.

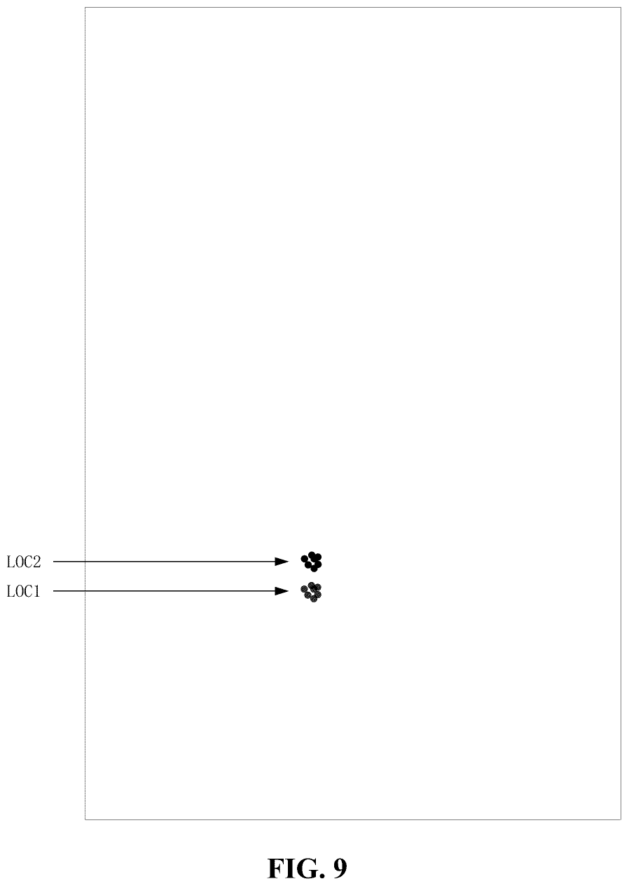

At a moment t2, first, the second image P1 displayed at t1 is used as a first image at t2; then, the pixel value of each pixel point in P1 is reduced to obtain an updated P1; afterwards, a second image P2 displayed at t2 is generated based on the updated P1 and the location of the particles updated at t2. FIG. 9 is a schematic diagram of a second image displayed at t2. With reference to FIG. 9, P2 not only comprises each pixel point in the updated first image P1 corresponding to the location LOC1 of the particles at t1, but also comprises particles in the location updated as LOC2 at t2.

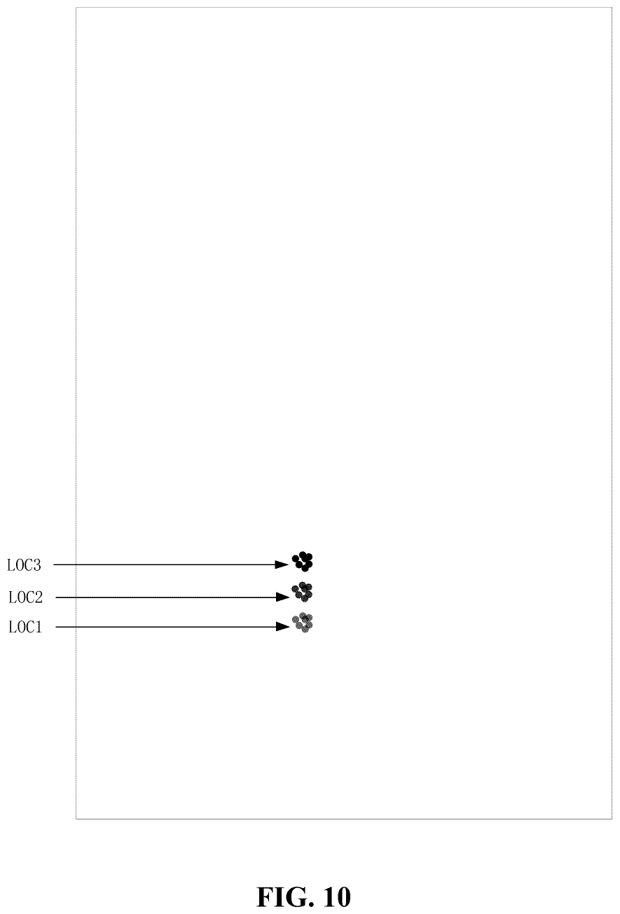

At a moment t3, first, the second image P2 displayed at t2 is used as a first image at t3; then, the pixel value of each pixel point in P2 is reduced to obtain an updated P2; afterwards, a second image P3 displayed at t3 is generated based on the updated P2 and the location of the particles updated at t3. FIG. 10 is a schematic diagram of a second image displayed at t3. With reference to FIG. 10, P3 not only comprises each pixel point in the updated first image P2 representing that the particles are in the location LOClat t1 and in the location LOC2 at t2, but also comprises particles in the location updated as LOC3 at t3.

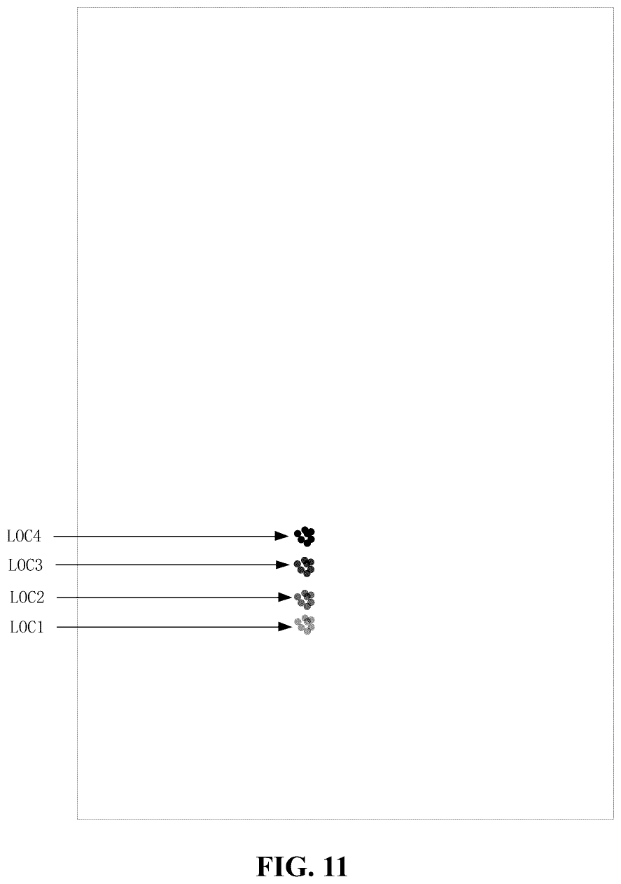

At a moment t4, first, the second image P3 displayed at t3 is used as a first image at t4; then, the pixel value of each pixel point in P3 is reduced to obtain an updated P3; afterwards, a second image P4 displayed at t4 is generated based on the updated P3 and the location of the particles updated at t4. FIG. 11 is a schematic diagram of a second image displayed at t4. With reference to FIG. 11, P4 not only comprises each pixel point in the updated first image P3 representing that the particles are in the location LOC1 at t1, in the location LOC2 at t2 and in the location LOC3 at t3, but also comprises particles in the location updated as LOC4 at t4.

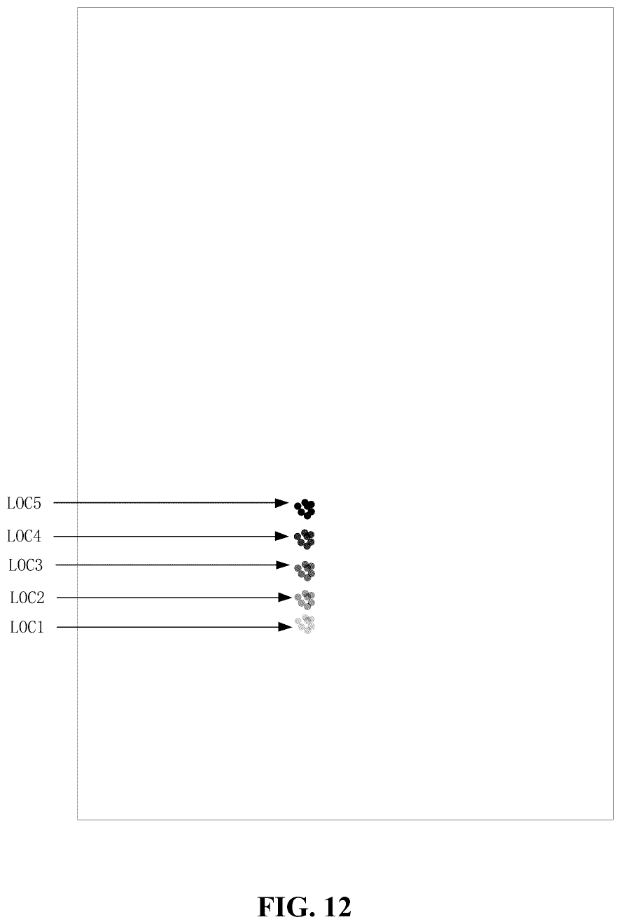

At a moment t5, first, the second image P4 displayed at t4 is used as a first image at t5; then, the pixel value of each pixel point in P4 is reduced to obtain an updated P4; afterwards, a second image P5 displayed at t5 is generated based on the updated P4 and the location of the particles updated at t5. FIG. 12 is a schematic diagram of a second image displayed at t5. With reference to FIG. 12, P5 not only comprises each pixel point in the updated first image P4 representing that the particles are in the location LOC1 at t1, in the location LOC2 at t2, in the location LOC3 at t3 and in the location LOC4 at t4, but also comprises particles in the location updated as LOC5 at t5.

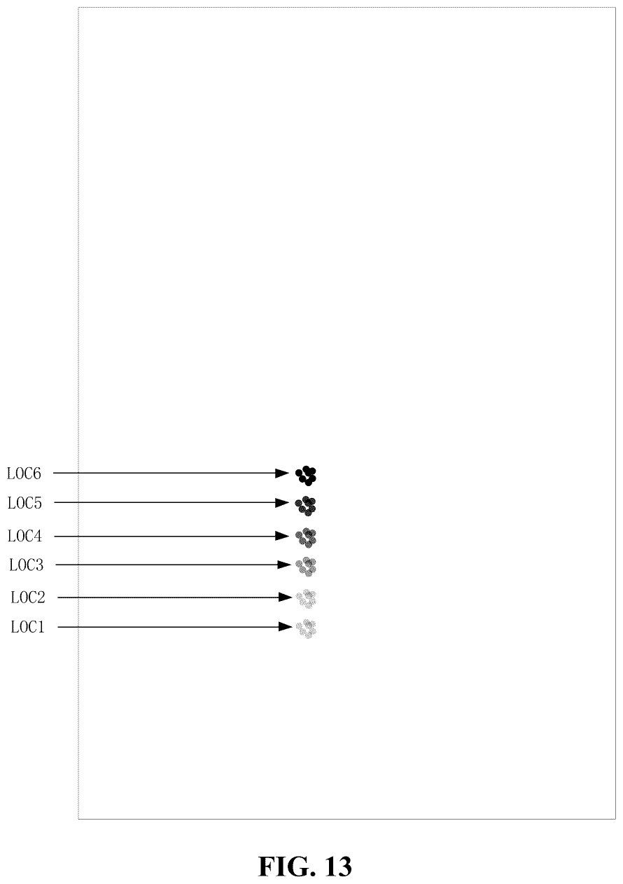

At a moment t6, first, the second image P5 displayed at t5 is used as a first image at t6; then, the pixel value of each pixel point in P5 is reduced to obtain an updated P5; afterwards, a second image P6 displayed at t6 is generated based on the updated P5 and the location of the particles updated at t6. FIG. 13 is a schematic diagram of a second image displayed at t6. With reference to FIG. 13, P6 not only comprises each pixel point in the updated first image P5 representing that the particles are in the location LOC1 at t1, in the location LOC2 at t2, in the location LOC3 at t3, in the location LOC4 at t4 and in the location LOC5 at t5, but also comprises particles in the location updated as LOC6 at t6.

Optionally, the updated first image may be generated through the following process: regarding each pixel point comprised in each particle in the first image, determining a product of a predetermined reduction coefficient and a pixel value of the pixel point as a pixel value of the pixel point in the updated first image, the predetermined reduction coefficient being less than 1.

Wherein the pixel value is taken for the three colors red green blue (RGB). In this way, the pixel value of the first image can be constantly reduced by multiplying the pixel value by a value less than one. As time elapses, for the particle whose position is updated at a moment farther away from the current moment, the RGB values of the pixels it includes are smaller, and for the particle whose position is updated at a moment closer to the current moment, the RGB values of the pixels it includes are the largest.

In practical application, when an object moves to a certain degree, the object will explode. For example, when fireworks rise to a certain degree, the fireworks will explode. The embodiments of the present disclosure may use two examples in order to realize the fireworks explosion effect.

In a first example, after S102 and S103 are performed one or multiple times, the attributes of the particles might satisfy a predetermined condition, i.e., the speed of the particles reaches a target speed, and/or the motion of the particles arrives at a target location. At this point, the distance between two adjacent particles may be increased; the particles are displayed based on the increased distance. Due to the increasing distance between the particles, the image area formed by the particles also expands, so that the explosion effect of fireworks is realized.

Wherein the target speed may be 0 or close to 0. It can be understood that since the particles will be affected by gravity and air resistance during rising, their speed will gradually decrease till to 0. At this point, increasing the distance between two adjacent particles will achieve the explosion of fireworks.

The target location may be any location in the rising process. The embodiments of the present disclosure may realize the explosion of fireworks before the speed of the particles decreases to 0, thereby improving the flexibility of fireworks explosion.

In a second example, after S102 and S103 are performed once or multiple times, the attributes of the particles might satisfy a predetermined condition, i.e., the speed of the particles reaches a target speed, and/or the motion of the particles arrives at a target location. At this point, a predetermined image sequence may be played, and a particle area included in any image in the predetermined image sequence is larger than a particle area included in a previous image.

Wherein the target speed and the target location may be referred to the above detailed illustration of the first example, which is not repeated here.

FIG. 6 shows a schematic diagram of an image sequence provided by the embodiments of the present disclosure. With reference to FIG. 6, 56 frames of images are arranged in the order from top to bottom and from left to right, and the particle areas included in these 56 frames of images become increasingly large, so that the explosion effect of the fireworks can be realized by playing the images in this order.

As seen from FIG. 6 further, the transparency of the particles become increasingly small in the order from top to bottom and from left to right, thereby realizing the dissipation of the fireworks during the explosion.

In the embodiments of the present disclosure, in increasing the distance between two adjacent particles, the distance can be increased at a fixed speed, that is, the distance between the particles is increased by a fixed multiple at fixed intervals; the distance can also be increased at a variable speed, that is, the distance between the particles is increased by a variable multiple at fixed intervals.

In order to increase the distance at a variable speed, first of all, a gradually decreasing amplifying speed may be generated; then, the amplifying speed is inputted to a first preset function to obtain an amplifying factor, the first preset function being used for increasing the amplifying factor based on different increasing speeds as the amplifying speed decreases gradually; finally, the distance between two adjacent particles is increased based on the amplifying factor.

Wherein the amplifying speed evenly decreases as time elapses. That is, the amplifying speed decreases at a fixed speed. In practical applications, the decreasing speed of the amplifying speed and an initial amplifying speed may be set, so that the amplifying speed at each time may be determined and further the amplifying factor at the time may be determined based on the amplifying speed.

In order to realize a variable increasing speed of the amplifying factor while the amplifying speed evenly decreases, the first preset function may be a function with different derivatives in different value ranges. The embodiments of the present disclosure may increase the distance between two adjacent particles through an ever-changing amplifying factor, which helps to improve the richness of the explosion effect of particles.

Further, the amplifying factor increases at a first increasing speed, a second increasing speed, a third increasing speed and a fourth increasing speed in this order, the first and third increasing speeds being less than or equal to a preset threshold, the second and fourth increasing speeds being grater than or equal to the preset threshold. In this way, fireworks may quickly expand at the beginning of the explosion, and tend to be stable when reaching a certain size. That is, the size changes slowly, and fireworks can be clearly watched. Afterwards, fireworks quickly expand and tend to be stable when reaching a given size. That is, the size changes quickly when fireworks are going to dissipate.

It is noteworthy that the above preset threshold is a value approximating 0.

In order to realize the relationship between the amplifying factor and the amplifying speed, the embodiments of the present disclosure propose the following formula:

$$SL = c \cdot ( 1.1 - a \cdot {( 3 \cdot {AS}^{2} - 2 \cdot {AS}^{3} )}^{10} - b \cdot ( 1 + {( 3 {( AS - 1 )}^{2} - 2 {( AS - 1 )}^{3} )}^{10} ) ) \qquad ( 1 )$$

where

$$a = \{ \begin{matrix}1 , & 1 \leq AS \leq 1 \\ 0 , & 1 < AS \leq 2\end{matrix} , b = \{ \begin{matrix}0 , & 1 \leq AS \leq 1 \\ 1 , & 1 < AS \leq 2\end{matrix} ,$$

SL is the amplifying factor, AS is the amplifying speed, c is a constant greater than 1.

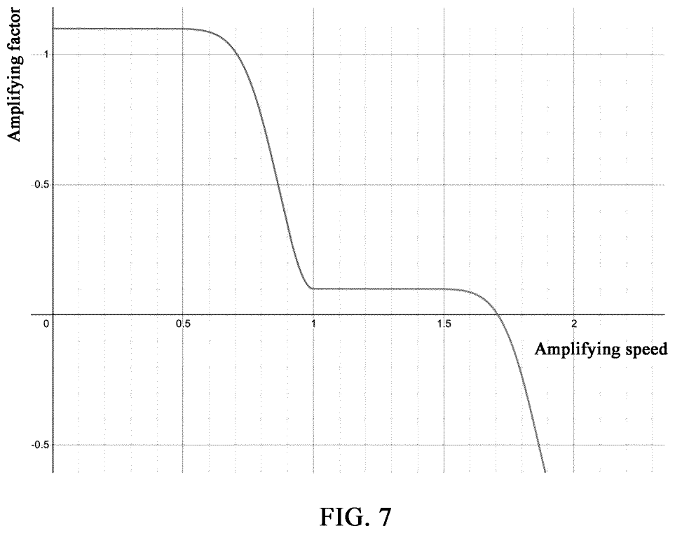

Based on Formula (1), FIG. 7 shows a schematic diagram of a relationship between the amplifying speed and the amplifying factor as provided by the embodiments of the present disclosure. In FIG. 7, the horizontal axis represents the amplifying speed, and the vertical axis represents the amplifying factor. As seen from FIG. 7, as the amplifying speed decreases, the amplifying factor first increases quickly and then tend to be gentle, i.e., no longer increases, and then quickly increases again and tend to be gentle.

Further, the embodiments of the present disclosure can simulate the dissipation process of the fireworks after explosion through the transparency of particles. The transparency is the largest at the beginning of the explosion, which represents that the fireworks do not dissipate yet. Then the transparency gradually decreases over time, which represents that the fireworks gradually dissipate, until the transparency decreases to a preset transparency. The preset transparency may usually be 0. Since only a small amount of computation is involved in modifying the transparency, the computation complexity needed to simulate the fireworks dissipation is effectively reduced.

In the embodiments of the present disclosure, when reducing the transparency, the transparency can be made synchronous with the amplifying speed based on the decrease of the amplifying speed, which improves the richness of the explosion of fireworks. Specifically, the transparency of the particles is reduced based on the amplifying speed, so that when displaying the particles based on the increased distance, the reduced transparency of the particles needs to be considered. That is, the particles are displayed based on the increased distance and the reduced transparency of the particles.

Wherein the transparency may be a function of the amplifying speed. In the embodiments of the present disclosure, the function may be referred to as a second preset function. The second preset function may output the gradually decreasing transparency as the transparency decreases gradually. The second preset function may be a monotonically increasing function.

$$H = max ( 0 , min ( \frac{AS}{IAS \cdot PR} , 1 ) ) \qquad ( 2 )$$

where H is the transparency, IAS is the initial transparency, i.e., the maximum transparency which may be 1, and PR is a configurable parameter.

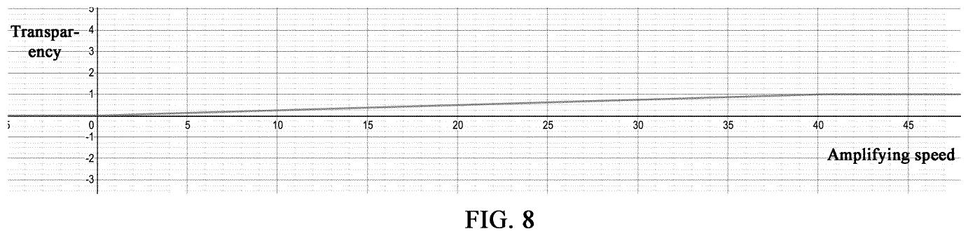

Based on Formula (2), FIG. 8 is a schematic diagram of a relationship between the amplifying speed and the transparency as provided by the embodiments of the present disclosure, wherein the horizontal axis is the amplifying speed, and the vertical axis is the transparency. As seen from FIG. 8, the transparency gradually decreases as the amplifying speed decreases.

Optionally, after reducing the transparency of the particles based on the amplifying speed, the transparency of the particles may be randomly reduced to a preset transparency.

Wherein the preset transparency is a corresponding transparency when the particles dissipate. For example, the preset transparency may be 0.

Specifically, the above random reduce may be selecting a portion of particles from the first number of particles and reducing the transparency of this portion of particles to the preset transparency. In this way, the transparency can be gradually reduced based on the amplifying speed until the particles dissipate, and based thereon, a portion of particles may dissipate in advance, thereby further enriching the fireworks effect.

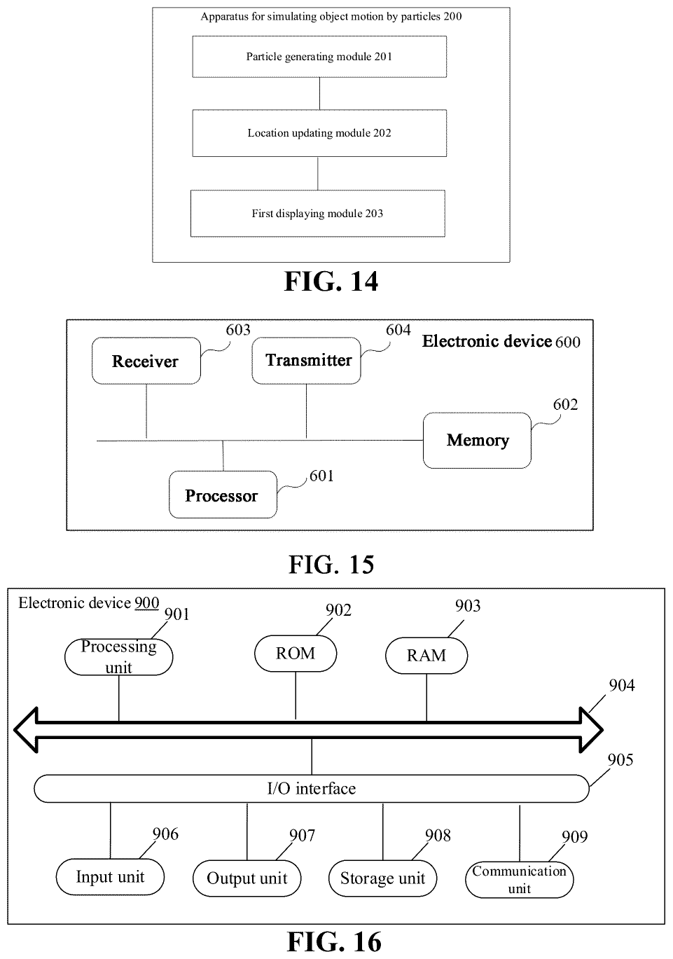

Corresponding to the method of simulate object motion by particles in the above embodiments, FIG. 14 shows a structural block diagram of an apparatus for simulate object motion by particles as provided by the embodiments of the present disclosure. For the sake of illustration, only parts related to the embodiments of the present disclosure are shown. With reference to FIG. 14, the apparatus 200 for simulating object motion by particles comprises: a particle generating module 201, a location update module 202 and a first display module 203.

Wherein the particle generating module 201 is configured for generating a first number of particles, each of the particles comprising one or more pixel points, the motion process of the first number of particles forming animation effects which are used for simulating motion effects of the object in a real environment.

The locating update module 202 is configured for updating a location of the particles based on a motion control parameter during the motion process, the motion control parameter being a parameter that affects the motion.

The first displaying module 203 is configured for displaying the particles based on the updated location of the particles.

Optionally, the motion control parameter comprises at least one of: a gravity parameter, an air resistance parameter, and an air disturbance parameter.

Optionally, the location update module 202 is further configured for: determining an acceleration of the particles based on the motion control parameter; updating the location of the particles based on the acceleration.

Optionally, the apparatus further comprises a distance increasing module and a second display module:

The distance increasing module being configured for, after the displaying the particles based on the updated location of the particles, increasing a distance between two adjacent ones of the particles when an attribute of the particles meets a preset condition, the preset condition comprising at least one of: a speed of the particles reaching a target speed, the particles moving to a target location.

The second display module being configured for displaying the particles based on the increased distance.

Optionally, the distance increasing module is further configured for generating a gradually decreasing amplifying speed when increasing the distance between two adjacent one of the particles; inputting the amplifying speed to a first preset function to obtain an amplifying factor, the first preset function being used for increasing the amplifying factor based on different increasing speeds as the amplifying speed gradually decreases; increasing the distance between two adjacent one of the particles based on the amplifying factor.

Optionally, the amplifying factor increases based on a first increasing speed, a second increasing speed, a third increasing speed and a fourth increasing speed in this order, the first increasing speed and the third increasing speed being less than or equal to a preset threshold, the second increasing speed and the fourth increasing speed being greater than or equal to the preset threshold.

Optionally, the apparatus further comprises a first transparency reducing module configured for reducing the transparency of the particles based on the amplifying speed.

Based on the first transparency reducing module, the second display module is further configured for displaying the particles based on the increased distance and the reduced transparency of the particles.

Optionally, the first transparency reducing module is further configured for:

inputting the amplifying speed to a second preset function to obtain the transparency of the particles, the second preset function being used for outputting a reduced transparency as the amplifying speed gradually decreases.

Optionally, the apparatus further comprises a second transparency reducing module configured for randomly reducing the transparency of the particles to a preset transparency after reducing the transparency of the particles based on the amplifying speed.

Optionally, the first display module 203 is further configured for:

Obtaining a first image displayed at a previous moment, the first image including the particles; reducing a pixel value of each pixel point included in the particles in the first image to obtain an updated first image; generating a second image based on the updated first image and the updated location of the particles; displaying the second image, the second image including pixel points whose pixel values are reduced and the pixels whose location is updated.

Optionally, the first display module 203 is further configured for, when reducing a pixel value of each pixel point included in the particles in the first image to obtain an updated first image, regarding each pixel point included in each particle in the first image, determining a product of a preset reduction coefficient and a pixel value of the pixel point as a pixel value of the pixel point in the updated first image, the preset reduction coefficient being less than 1.

Optionally, the apparatus further comprises:

An attribute setting module, configured for setting at least one of attributes of the first number of particles in an initial state: a shape formed by the first number of particles, a size of the shape, a color of the particles, a location of the particles, and a speed of the particles.

Optionally, the apparatus further comprises: after displaying the particles based on the updated location of the particles, playing a preset image sequence when the attribute of the particles meets a preset condition, a particle area included in any area in the preset image sequence being larger than a particle area included in a previous image, the preset condition comprising at least one of: the speed of the particles reaching a target speed, and the particles moving to a target location.

Optionally, the particle generating module 201 is further configured for: randomly generating a second number of particles; determining particles located in a target image area in the second number of particles as the first number of particles, the target image area including particles needed to form a target display object.

The apparatus provided by this embodiment may be used for implementing the technical solution of the method embodiment shown in FIG. 3, with similar implementation principle and technical effects, which is not detailed here.

FIG. 15 shows a structural block diagram of an electronic device 600 provided by the embodiments of the present disclosure. The electronic device 600 comprises a memory 602 and at least one processor 601;
Wherein the memory 602 stores computer executable instructions;
The at least one processor 601 executes the computer executable instructions stored in the memory 602 to cause the electronic device 600 to perform the method of simulating object motion by particles in FIG. 3.

In addition, the electronic device 600 may further comprise a receiver 603 and a sender 604, the receiver 603 being configured for receiving information from other apparatus or device and forwarding the same to the processor 601, the sender 604 being configured for sending the information to other apparatus or device.

Further, with reference to FIG. 16, this figure shows a structural schematic diagram of an electronic device 900 suitable for implementing the embodiments of the present disclosure, which may be a terminal device. The terminal device may include, without limitation to, a mobile terminal with an image capturing function, such as a mobile phone, a laptop computer, a digital broadcast receiver, a personal digital assistant (PDA), a portable android device (PAD), a portable multimedia player (PMP), an on-board terminal (e.g., on-board navigation terminal) and the like, as well as a fixed terminal, such as a digital TV, a desktop computer and the like. The electronic device shown in FIG. 16 is merely an example and should not be construed to impose any limitations on the functionality and use scope of the embodiments of the present disclosure.

As shown in FIG. 16, the electronic device 900 may comprise a processing unit (e.g., a central processor, a graphics processor) 901 which is capable of performing various appropriate actions and processes in accordance with programs stored in a read only memory (ROM) 902 or programs loaded from storage unit 908 to a random access memory (RAM) 903. In the RAM 903, there are also stored various programs and data required by the electronic device 900 when operating. The processing unit 901, the ROM 902 and the RAM 903 are connected to one another via a bus 904. An input/output (I/O) interface 905 is also connected to the bus 904.

Usually, the following units may be connected to the I/O interface 905: an input unit 906 including a touch screen, a touch pad, a keyboard, a mouse, a camera, a microphone, an accelerometers, a gyroscope, or the like; an output unit 907, such as a liquid-crystal display (LCD), a loudspeaker, a vibrator, or the like; a storage unit 908, such as a a magnetic tape, a hard disk or the like; and a communication unit 909. The communication unit 909 allows the electronic device 900 to perform wireless or wired communication with other device so as to exchange data with other device. While FIG. 16 shows the electronic device 900 with various units, it should be understood that it is not required to implement or have all of the illustrated units. Alternatively, more or less units may be implemented or exist.

Specifically, based on the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication unit 909, or installed from the storage unit 908, or installed from the ROM 902. The computer program, when executed by the processing unit 901, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

The above computer readable medium may be included in the above-mentioned electronic device; and it may also exist alone without being assembled into the electronic device.

The computer readable storage medium carries one or more programs which, when executed by an electronic device, cause the electronic device to perform the method described in the above embodiments.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products based on various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware. Wherein the name of a unit does not form any limitation to the unit per se. For example, the first obtaining unit may further be described as a “unit for obtaining at least two Internet Protocol addresses.”

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, units or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In a first example based on a first aspect, the embodiments of the present disclosure provide a method of simulating object motion by particles, comprising:
Generating a first number of particles, each of the particles comprising one or more pixel points, the motion process of the first number of particles forming animation effects which are used for simulating motion effects of the object in a real environment;
Updating a location of the particles based on a motion control parameter during the motion process, the motion control parameter being a parameter that affects the motion;
Displaying the particles based on the updated location of the particles.

Based on the first example based on the first aspect, in a second example based on the first aspect, the motion control parameter comprises at least one of: a gravity parameter, an air resistance parameter, and an air disturbance parameter.

Based on the first example based on the first aspect, in a third example based on the first aspect, the updating a location of the particles based on a motion control parameter comprises:
Determining an acceleration of the particles based on the motion control parameter;
Updating the location of the particles based on the acceleration.

Based on the first example based on the first aspect, in a fourth example based on the first aspect, after the displaying the particles based on the updated location of the particles, there is further comprised:

Increasing a distance between two adjacent ones of the particles when an attribute of the particles meets a preset condition, the preset condition comprising at least one of: a speed of the particles reaching a target speed, the particles moving to a target location.

Displaying the particles based on the increased distance.

Based on the fourth example based on the first aspect, in a fifth example based on the first aspect, the increasing a distance between two adjacent ones of the particles comprises:
Generating a gradually decreasing amplifying speed;
Inputting the amplifying speed to a first preset function to obtain an amplifying factor, the first preset function being used for increasing the amplifying factor based on different increasing speeds as the amplifying speed gradually decreases;
Increasing the distance between two adjacent ones of the particles based on the amplifying factor.

Based on the fifth example based on the first aspect, in a sixth example based on the first aspect, the amplifying factor increases based on a first increasing speed, a second increasing speed, a third increasing speed and a fourth increasing speed in this order, the first increasing speed and the third increasing speed being less than or equal to a preset threshold, the second increasing speed and the fourth increasing speed being greater than or equal to the preset threshold.

Based on the fifth example based on the first aspect, in a seventh example based on the first aspect, there is further comprised:

Reducing the transparency of the particles based on the amplifying speed.

The displaying the particles based on the increased distance comprising:

Displaying the particles based on the increased distance and the reduced transparency of the particles.

Based on the seventh example based on the first aspect, in an eighth example based on the first aspect, the reducing the transparency of the particles based on the amplifying speed comprises:

Inputting the amplifying speed to a second preset function to obtain the transparency of the particles, the second preset function being used for outputting a reduced transparency as the amplifying speed gradually decreases.

Based on the seventh example based on the first aspect, in a ninth example based on the first aspect, after the reducing the transparency of the particles based on the amplifying speed, there is further comprised:

Randomly reducing the transparency of the particles to a preset transparency.

Based on the first example based on the first aspect, in a tenth example based on the first aspect, the displaying the particles based on the updated location of the particles comprises:
Obtaining a first image displayed at a previous moment, the first image including the particles;
Reducing a pixel value of each pixel point included in the particles in the first image to obtain an updated first image;
Generating a second image based on the updated first image and the updated location of the particles;
Displaying the second image, the second image including pixel points whose pixel values are reduced and the pixels whose location is updated.

Based on the tenth example based on the first aspect, in an eleventh example based on the first aspect, the reducing a pixel value of each pixel point included in the particles in the first image to obtain an updated first image comprises:

Regarding each pixel point included in each particle in the first image, determining a product of a preset reduction coefficient and a pixel value of the pixel point as a pixel value of the pixel point in the updated first image, the preset reduction coefficient being less than 1.

Based on any of the first to eleventh examples based on the first aspect, in a twelfth example based on the first aspect, the method further comprises:

Setting at least one of attributes of the first number of particles in an initial state: a shape formed by the first number of particles, a size of the shape, a color of the particles, a location of the particles, and a speed of the particles.

Based on the first example based on the first aspect, in a thirteenth example based on the first aspect, after the displaying the particles based on the updated location of the particles, there is further comprised:

Playing a preset image sequence when the attribute of the particles meets a preset condition, a particle area included in any area in the preset image sequence being larger than a particle area included in a previous image, the preset condition comprising at least one of: the speed of the particles reaching a target speed, and the particles moving to a target location.

Based on the first example based on the first aspect, in a fourteenth example based on the first aspect, the generating a first number of particles comprises:
randomly generating a second number of particles;
determining particles located in a target image area in the second number of particles as the first number of particles, the target image area including particles needed to form a target display object.

In a first example based on a second aspect, the embodiments of the present disclosure provide an apparatus for simulating object motion by particles, comprising:
A particle generating module, configured to generating a first number of particles, each of the particles comprising one or more pixel points, the motion process of the first number of particles forming animation effects which are used for simulating motion effects of the object in a real environment;
A location updating module, configured to updating a location of the particles based on a motion control parameter during the motion process, the motion control parameter being a parameter that affects the motion;
A first displaying module, configured to displaying the particles based on the updated location of the particles.

Based on the first example based on the second aspect, in a second example based on the second aspect, the motion control parameter comprises at least one of: a gravity parameter, an air resistance parameter, and an air disturbance parameter.

Based on the first example based on the second aspect, in a third example based on the second aspect, the updating module is further configured for: determining an acceleration of the particles based on the motion control parameter; updating the location of the particles based on the acceleration.

Based on the first example based on the second aspect, in a fourth example based on the second aspect, the apparatus further comprises a distance increasing module and a second displaying module:

The distance increasing module being configured for, after the displaying the particles based on the updated location of the particles, increasing a distance between two adjacent ones of the particles when an attribute of the particles meets a preset condition, the preset condition comprising at least one of: a speed of the particles reaching a target speed, the particles moving to a target location.

The second displaying module being configured for displaying the particles based on the increased distance.

Based on the fourth example based on the second aspect, in a fifth example based on the second aspect, the distance increasing module is further configured for: when increasing the distance between two adjacent ones of the particles, generating a gradually decreasing amplifying speed; inputting the amplifying speed to a first preset function to obtain an amplifying factor, the first preset function being used for increasing the amplifying factor based on different increasing speeds as the amplifying speed gradually decreases; increasing the distance between two adjacent ones of the particles based on the amplifying factor.

Based on the fifth example based on the second aspect, in a sixth example based on the second aspect, the amplifying factor increases based on a first increasing speed, a second increasing speed, a third increasing speed and a fourth increasing speed in this order, the first increasing speed and the third increasing speed being less than or equal to a preset threshold, the second increasing speed and the fourth increasing speed being greater than or equal to the preset threshold.

Based on the fifth example based on the second aspect, in a seventh example based on the second aspect, the apparatus further comprises a first transparency reducing module, configured for reducing the transparency of the particles based on the amplifying speed.

Based on the first transparency reducing module, the second display module is further configured for displaying the particles based on the increased distance and the reduced transparency of the particles.

Based on the seventh example based on the second aspect, in an eighth example based on the second aspect, the first transparency reducing module is further configured for:

Inputting the amplifying speed to a second preset function to obtain the transparency of the particles, the second preset function being used for outputting a reduced transparency as the amplifying speed gradually decreases.

Based on the seventh example based on the second aspect, in a ninth example based on the second aspect, the apparatus further comprises a second transparency reducing module, configured for, after the reducing the transparency of the particles based on the amplifying speed, randomly reducing the transparency of the particles to a preset transparency.

Based on the first example based on the second aspect, in a tenth example based on the second aspect, the first displaying module is further configured for:

Obtaining a first image displayed at a previous moment, the first image including the particles; reducing a pixel value of each pixel point included in the particles in the first image to obtain an updated first image; generating a second image based on the updated first image and the updated location of the particles; displaying the second image, the second image including pixel points whose pixel values are reduced and the pixels whose location is updated.

Based on the tenth example based on the second aspect, in an eleventh example based on the second aspect, the first displaying module is further configured for: when reducing a pixel value of each pixel point included in the particles in the first image to obtain an updated first image, regarding each pixel point included in each particle in the first image, determining a product of a preset reduction coefficient and a pixel value of the pixel point as a pixel value of the pixel point in the updated first image, the preset reduction coefficient being less than 1.

Based on any of the first to eleventh examples based on the second aspect, in a twelfth example based on the second aspect, the apparatus further comprises:

An attribute setting module, configured for setting at least one of attributes of the first number of particles in an initial state: a shape formed by the first number of particles, a size of the shape, a color of the particles, a location of the particles, and a speed of the particles.

Based on the first example based on the second aspect, in a thirteenth example based on the second aspect, the apparatus further comprises: after the displaying the particles based on the updated location of the particles, playing a preset image sequence when the attribute of the particles meets a preset condition, a particle area included in any area in the preset image sequence being larger than a particle area included in a previous image, the preset condition comprising at least one of: the speed of the particles reaching a target speed, and the particles moving to a target location.

Based on the first example based on the second aspect, in a fourteenth example based on the second aspect, the particle generating module is further configured for: randomly generating a second number of particles; determining particles located in a target image area in the second number of particles as the first number of particles, the target image area including particles needed to form a target display object.

In a third aspect, based on one or more embodiments of the present disclosure, an electronic device is provided, comprising: at least one processor and a memory;

The memory storing computer executable instructions;

The processor executing the computer executable instructions stored in the memory to cause the electronic device to perform a method as described in the first aspect.

In a fourth aspect, based on one or more embodiments of the present disclosure, a computer-readable storage medium is provided, on which computer executable instructions are stored, the computer executable instructions, when executed by a processor, causing a computing device to perform a method as described in the first aspect.

In a fifth aspect, based on one or more embodiments of the present disclosure, a computer program is provided, the computer program being used for performing a method as described in the first aspect.

In a sixth aspect, based on one or more embodiments of the present disclosure, a computer program product is provided, comprising a computer program which, when executed by a processor, performing a method as described in the first aspect.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

What is claimed is:

1. A method of simulating an object motion by particles, comprising:
generating a first number of particles, each of the particles comprising one or more pixel points, the motion process of the first number of particles forming animation effects, the animation effects being used for simulating motion effects of the object in a real environment;
updating a location of the particles based on a motion control parameter during the motion process, the motion control parameter being a parameter that affects the motion; and
displaying the particles based on the updated location of the particles.

2. The method of claim 1, wherein the motion control parameter comprises at least one of: a gravity parameter, an air resistance parameter, and an air disturbance parameter.

3. The method of claim 1, wherein updating the location of the particles based on the motion control parameter comprises:
determining an acceleration of the particles based on the motion control parameter; and
updating the location of the particles based on the acceleration.

4. The method of claim 1, wherein after displaying the particles based on the updated location of the particles, further comprising:
increasing a distance between two adjacent ones of the particles in the event that an attribute of the particles meets a preset condition, the preset condition comprising at least one of: a speed of the particles reaching a target speed, the particles moving to a target location; and
displaying the particles based on the increased distance.

5. The method of claim 4, wherein increasing a distance between the two adjacent ones of the particles comprises:
generating a gradually decreasing amplifying speed;
inputting the amplifying speed to a first preset function to obtain an amplifying factor, the first preset function being used for increasing the amplifying factor based on different increasing speeds as the amplifying speed gradually decreases; and
increasing the distance between the two adjacent ones of the particles based on the amplifying factor.

6. The method of claim 5, wherein the amplifying factor increases based on an order of a first increasing speed, a second increasing speed, a third increasing speed and a fourth increasing speed, the first increasing speed and the third increasing speed being less than or equal to a preset threshold, the second increasing speed and the fourth increasing speed being greater than or equal to the preset threshold.

7. The method of claim 5, further comprising:
reducing a transparency of the particles based on the amplifying speed;
wherein displaying the particles based on the increased distance comprising:
displaying the particles based on the increased distance and the reduced transparency of the particles.

8. The method of claim 7, wherein reducing the transparency of the particles based on the amplifying speed comprises; and
inputting the amplifying speed to a second preset function to obtain the transparency of the particles, the second preset function being used for outputting a reduced transparency as the amplifying speed gradually decreases.

9. The method of claim 7, wherein after reducing the transparency of the particles based on the amplifying speed, further comprising:
randomly reducing the transparency of the particles to a preset transparency.

10. The method of claim 1, wherein displaying the particles based on the updated location of the particles comprises:
obtaining a first image displayed at a previous time point, the first image including the particles;
reducing a pixel value of each pixel point included in the particles in the first image to obtain an updated first image;
generating a second image based on the updated first image and the updated location of the particles; and
displaying the second image, the second image including pixel points of which pixel values are reduced while the pixels of which location is updated.

11. The method of claim 10, wherein reducing a pixel value of each pixel point included in the particles in the first image to obtain an updated first image comprises:
for each pixel point included in each particle in the first image, determining a product of a preset reduction coefficient and a pixel value of the pixel point as a pixel value of the pixel point in the updated first image, the preset reduction coefficient being less than 1.

12. The method of claim 1, further comprising:
setting at least one of attributes of the first number of particles in an initial state: a shape formed by the first number of particles, a size of the shape, a color of the particles, a location of the particles, and a speed of the particles.

13. The method of claim 1, wherein after displaying the particles based on
the updated location of the particles, further comprising:
playing a preset image sequence in the event that the attribute of the particles meets a preset condition, a particle area included in any area in the preset image sequence being larger than a particle area included in a previous image, the preset condition comprising at least one of: a speed of the particles reaching a target speed, and the particles moving to a target location.

14. The method of claim 1, wherein generating a first number of particles comprises:
randomly generating a second number of particles; and
determining particles located in a target image area in the second number of particles as the first number of particles, the target image area including particles needed to form a target display object.

15. (canceled)

16. An electronic device, comprising: at least one processor and a memory;
the memory storing computer executable instructions;
the processor executing the computer executable instructions stored in the memory to cause the electronic device to perform a method:
generating a first number of particles, each of the particles comprising one or more pixel points, the motion process of the first number of particles forming animation effects, the animation effects being used for simulating motion effects of the object in a real environment;
updating a location of the particles based on a motion control parameter during the motion process, the motion control parameter being a parameter that affects the motion; and
displaying the particles based on the updated location of the particles.

17-18. (canceled)

19. A computer program product being stored on a non-transitory computer storage medium comprising a computer program which, when executed by a processor, performs a method of:
generating a first number of particles, each of the particles comprising one or more pixel points, the motion process of the first number of particles forming animation effects, the animation effects being used for simulating motion effects of the object in a real environment;
updating a location of the particles based on a motion control parameter during the motion process, the motion control parameter being a parameter that affects the motion; and
displaying the particles based on the updated location of the particles.

20. The electronic device of claim 16, wherein the motion control parameter comprises at least one of: a gravity parameter, an air resistance parameter, and an air disturbance parameter.

21. The electronic device of claim 16, wherein updating the location of the particles based on the motion control parameter comprises:
determining an acceleration of the particles based on the motion control parameter; and
updating the location of the particles based on the acceleration.

22. The electronic device of claim 16, wherein after displaying the particles based on the updated location of the particles, further comprising:
increasing a distance between two adjacent ones of the particles in the event that an attribute of the particles meets a preset condition, the preset condition comprising at least one of: a speed of the particles reaching a target speed, the particles moving to a target location; and
displaying the particles based on the increased distance.

23. The electronic device of claim 22, wherein increasing a distance between the two adjacent ones of the particles comprises:
generating a gradually decreasing amplifying speed;
inputting the amplifying speed to a first preset function to obtain an amplifying factor, the first preset function being used for increasing the amplifying factor based on different increasing speeds as the amplifying speed gradually decreases; and
increasing the distance between the two adjacent ones of the particles based on the amplifying factor.
